(19) United States
(12) Patent Application Publication
(10) Pub. No.: US 2025/0077895 A1
(43) Pub. Date: Mar. 6, 2025

(54) FUSING IN-CONTEXT LEARNING AND FINE-TUNING FOR LANGUAGE MODEL NEURAL NETWORKS

(71) Applicant: Google LLC, Mountain View, CA (US)

(72) Inventors: Xinyi Wang, New York, NY (US); John Frederick Wieting, New York, NY (US); Jonathan Hudson Clark, Seattle, WA (US)

(21) Appl. No.: 18/826,005

(22) Filed: Sep. 5, 2024

Related U.S. Application Data
(60) Provisional application No. 63/580,699, filed on Sep. 5, 2023.

(51) Int. Cl. G06N 3/0985; G06N 3/045

(52) U.S. Cl. CPC G06N 3/0985; G06N 3/045

(57) ABSTRACT

Methods, systems, and apparatuses, including computer programs encoded on computer storage media, for configuring a set of language model neural networks, e.g., a first large language model and a second smaller-sized language model, and performing a machine learning task on new inputs using the set of language model neural networks. Configuring the language model neural networks and performing a machine learning task can include leveraging the ability of a first large language model to follow prompt-engineered instructions and perform chain-of-thought reasoning, while also fine-tuning a second, smaller language model neural network to optimize the machine learning task performance.

### CROSS-REFERENCE TO RELATED APPLICATIONS

This application claims priority to U.S. Provisional Application No. 63/580,699, filed Sep. 5, 2023, the contents of which are incorporated herein by reference in their entirety.

### BACKGROUND

This specification relates to processing inputs using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification generally describes a system implemented as computer programs on one or more computers in one or more locations that configures a set of language model neural networks to perform a machine learning task and performs inference for the task on a new input using the set of language model neural networks.

That is, the system can process a new input for a machine learning task by processing a first input sequence that includes a first prompt for the machine learning task and the new input using a first language model neural network from the set of neural networks to generate an intermediate output for the machine learning task. Then, the system processes a second input sequence that includes the intermediate output generated by the first language model neural network and the new input using a second language model neural network from the set of neural networks to generate a final output for the machine learning task.

The subject matter described in this specification can be implemented in particular embodiments so as to realize one or more of the following advantages.

Large Language Models (LLMs) have demonstrated impressive capabilities on a wide variety of tasks. Conventional training paradigms for task-specific adaptation for large language models (LLMs) currently tend to fall within either in-context learning (ICL) or full fine-tuning. Each of these comes with their own tradeoffs based on available data, model size, compute cost, ease-of-use, and final quality. Because of these often complex trade-offs, neither solution performs well across-the-board.

Very large LLMs, models with sizes over a certain threshold, exhibit emergent model capabilities, i.e., impressive generalization to new tasks and ability to produce logical reasoning to solve problems. Although there is evidence that fine-tuning a model on task data can lead to superior task-specific adaptation of the model compared to ICL, the size of the very large LLM makes fine-tuning for task-specific adaptation prohibitively expensive and impractical.

Moderately-sized LLMs, models with sizes under a certain threshold, do not exhibit emergent model capabilities to the same degree as very large LLMs, but they offer the advantage of being more easily fine-tuned for task-specific adaptation. Therefore, moderately-sized LLMs benefit from the better handling of nuances and enhanced task specialization that fine-tuning a model offers.

When an LLM needs to perform a machine learning task that significantly differs from tasks associated with the general data that the model was trained on or when improved model accuracy is critical for the task, training to achieve task-specific adaptation is important.

This specification describes techniques for using multiple language models to perform a machine learning task in a manner that leverages both ICL and fine-tuning. These techniques ensure that the task-specific adaptation for the multiple language models effectively leverage each model's capacity, leading to maximum improvement per unit of computational cost, e.g., CPU hours or memory footprint, for each language model.

In particular, the described techniques allow the system to leverage the ability of very large language models to follow prompt-engineered instructions and perform chain-of-thought reasoning, while also fine-tuning a modestly-sized LLM to optimize the performance on a target task. Thus, the system fuses both ICL and fine-tuning to arrive at a technique that does not require any fine-tuning of a very large language model but generates performance that exceeds that of performing ICL on the very large LLM and that of fine-tuning a smaller LLM. In other words, because model performance is additive, i.e., using two models to perform a task results in better outcomes than relying on a single model, task-specific adaptation of a model composed of a very large LLM and moderately-sized LLMs using ICL and fine-tuning respectively ensures efficient use of computational resources while maximizing the model's performance improvement.

The details of one or more embodiments of the subject matter of this specification are set forth in the accompanying drawings and the description below.

Other features, aspects, and advantages of the subject matter will become apparent from the description, the drawings, and the claims.

### DESCRIPTION OF DRAWINGS

FIG. 1 shows an example neural network system.

FIG. 2 is a flow diagram of an example process to perform inference for a new input of a machine learning task using the set of language model neural networks.

FIG. 3 is a flow diagram of an example process for configuring a first language model neural network and a second language model neural network to perform a machine learning task.

FIG. 4 shows an example of the performance of the described techniques.

Like reference numbers and designations in the various drawings indicate like elements.

### DETAILED DESCRIPTION

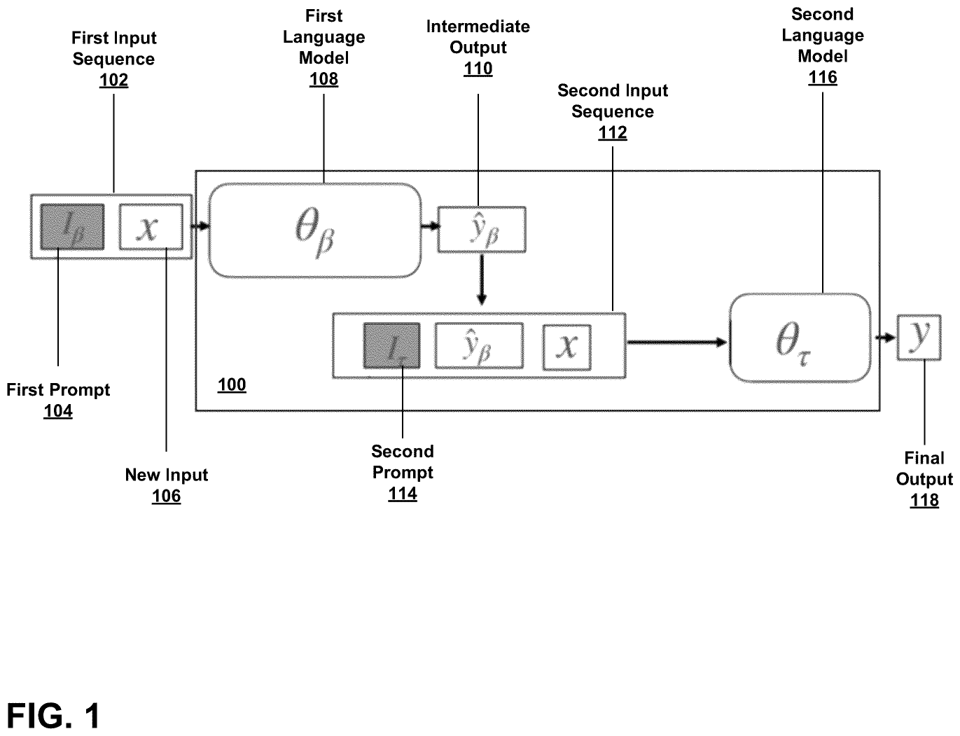

FIG. 1 shows an example neural network system 100. The neural network system 100 is an example of a system implemented as computer programs on one or more computers in one or more locations, in which the systems, components, and techniques described below can be implemented.

The neural network system 100 is a system that configures a set of language model neural networks, e.g., a first language model 108 and a second language model 116, to perform a machine learning task, and performs inference for the task on new inputs, e.g., new input 106, using the set of language model neural networks.

Generally, the first language model 108 is larger than the second language model 116.

The second language model 116 can be referred to as a “smaller” neural network because the second language model 116 has a relatively small model size, i.e., number of parameters, number of layers, or both, relative to a larger neural network, e.g., the first language model 108.

For example, relative to the first language model 108, the second language model 116 can have fewer parameters, e.g., because the neural network includes fewer self-attention layer blocks, because the hidden states operated on by the self-attention layer blocks have a smaller dimensionality, because the self-attention layer blocks use fewer attention heads, or some combination of the above.

As an example ‘larger’ first language model 108 and ‘smaller’ second language model 116, the first language model 108 can be a pre-trained LLM such as Palm-2 540B with 118 layers, 48 attention heads for multi-head attention, a 18,432 input dimension for multi-head attention within the transformer architecture of the neural network and 540 billion parameters (as described in ArXiv: 2204.02311), and the second language model can be a pre-trained LLM such as Palm-2 8B with 32 layers, 16 attention heads for multi-head attention, a 4,096 input dimension for multi-head attention and 8 billion parameters (also as described in ArXiv: 2204.02311).

Furthermore, the first language model can also be instruction-tuned models using methods such as FLAN, i.e., a method of fine-tuning language models on a collection of dataset phrased as instructions. For example, the first language model 108 can be FLAN-Palm or FLAN-T5 as described in ArXiv: 2210.11416. Instruction fine-tuned models provide significant performance improvements using ICL compared to using a broadly pre-trained model that has not undergone additional training to better understand and respond to instructions.

In some implementations, the first language model 108 is pre-trained on a second, different machine learning task that is different from the machine learning task the system 100 performs.

In other implementations, in addition to the features previously mentioned in the last paragraph, the second language model 116 is pre-trained on a third, different machine learning task that is different from the machine learning task the system 100 performs and then fine-tuned on the machine learning task the system 100 performs, e.g., fine-tuned on the machine learning task using parameter-efficient fine-tuning.

In some cases, the second machine learning task, the third machine learning task, or both is a language modeling task.

For example, the machine learning task can be to solve arithmetic word problems, the second machine learning task can be to summarize word passages, and the third machine learning task can be a classification task where the model is asked to predict whether the provided answer to the question is supported by a given word passage context. The machine learning task, the second machine learning task, and the third machine learning tasks are all different language modeling tasks.

Generally, using machine learning models pre-trained on different tasks benefits the system's 100 machine learning task performance by avoiding redundancy, and having the models contribute specialized knowledge to solving the overall machine learning task. As a result, the composite model is a more robust and accurate model.

For example, considering the previous examples of a machine learning task, a second machine learning task, and a third machine learning task, although all machine learning tasks are different, the second and third tasks are intuitively related to the machine learning. That is, in order to solve a arithmetic word problem one typically needs to be able to extract relevant information from the word problem (i.e., summarize a word passage), perform arithmetic operations using the extracted relevant information, and check that the result solves the posed arithmetic word problem (i.e., predict whether the provided answer to the question is supported by a given word passage context). The system 100 operates in two modes: a configuration mode and an inference mode.

During inference mode, the system 100 can receive a new input 106 for the machine learning task.

The system 100 can process a first input sequence 102 that includes a first prompt 104 for the machine learning task and the new input 106 using a first language model neural network 108 from the set of neural networks to generate an intermediate output 110 for the machine learning task.

As a particular example, the first prompt 104 can be a “chain-of-thought prompt” for the machine learning task that causes the first language model 108 neural network to generate text describing one or more reasoning steps required to arrive at a final output 118 for the machine learning task. The text describing the one or more reasoning steps can then be the intermediate output 110 for the task.

The system 100 then processes a second input sequence 112 that includes the intermediate output 110 generated by the first language model neural network 108 and the new input 106 using a second language model neural network 116 from the set of neural networks to generate a final output 118 for the machine learning task.

In some implementations, the second input sequence 112 also includes a second prompt 114. The second prompt 114 serves an additional way to better align a new input with the distribution of data seen during pre-training. That is, the second prompt 114 serves as an additional conditioning factor to increase the likelihood of a correct final output 118.

For example, the second prompt 114 can be instructions to generate reasoning and explanations.

As another example, the second prompt 114 can specify guidance for how to use the generated intermediate output 110.

Thus, the system 100 processes an output, i.e., the intermediate output 110, generated by one neural network, i.e., the first language model 108, along with the original input, i.e., the new input 106, for the task using another neural network, i.e., the second language model 116, to generate the final output 118 for the machine learning task.

As will be described in more detail below, the composition of a first language model 108 and second language model 116 to perform a machine learning task allows the system 100 to leverage a pre-trained very large language model neural network, i.e., the first language model 108, that is able to benefit from in-context learning to generate a high-quality intermediate output 110 and then use a smaller, fine-tuned language model neural network, i.e., the second language model 116, to use the intermediate output 110 and the original input, i.e., the new input 106, to generate an improved final output 118 for the task, i.e., improved by making use of the intermediate output relative to the output that would have been generated by the first language model 108.

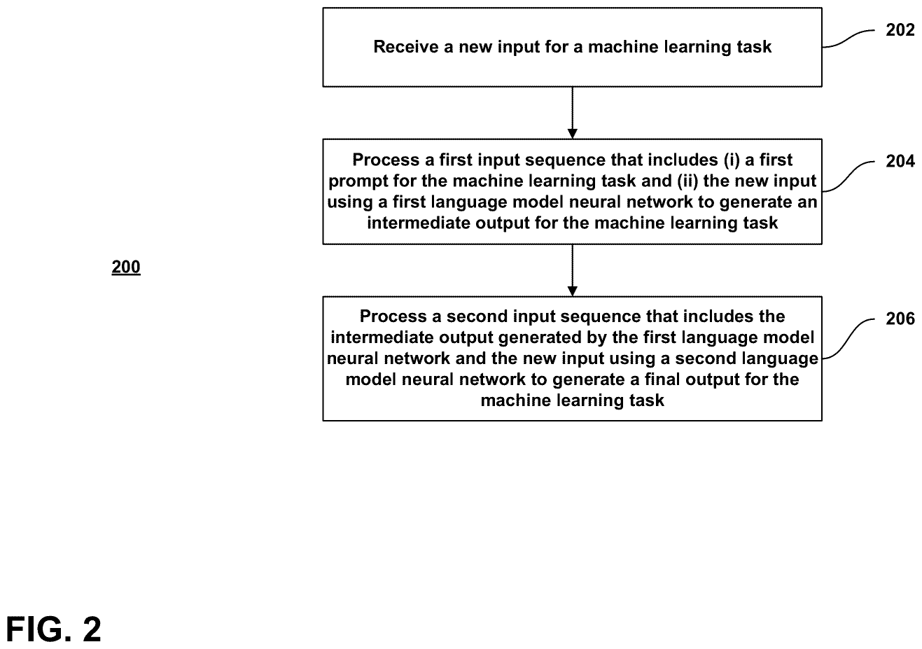

Further details of performing inference for a new input 106 of a machine learning task using the set of language model neural networks are described below with reference to FIG. 2.

Prior to the system 100 using the set of neural networks in inference mode, the system 100 configures the set of neural networks to perform the task in configuration mode.

In particular, the system 100 obtains training data that includes a plurality of training inputs for the machine learning task and a respective target output for the machine learning task for each of the training inputs.

The system 100 also obtains data specifying a first prompt 104 for the machine learning task, e.g., a chain-of-thought prompt as described above.

The system 100 can then repeatedly perform the following described process using the training inputs and corresponding target outputs in order to fine-tune, i.e., further train, the second language model 116 neural network. That is, at each of multiple iterations, the system can obtain, e.g., by random sampling, a set of one or more training inputs and corresponding target outputs.

For each of the training inputs, the system 100 processes a first input sequence 102 that includes the first prompt 104 for the machine learning task and the training input, in place of the new input 106 as described above during inference mode, using the first language model neural network 108 to generate an intermediate output 110 for the machine learning task and processes a second input sequence 112 that includes the intermediate output 110 generated by the first language model neural network 108 and the training input using the second language model neural network 116 to generate a training output, in place of the final output 118 as described above during inference mode, for the machine learning task.

The system 100 then trains the second language model 116 neural network to perform the machine learning task using an objective function that is based on, for each training input, the training output for the training input and the target output for the training input.

For example, the system 100 can perform this training using parameter-efficient fine-tuning (PEFT).

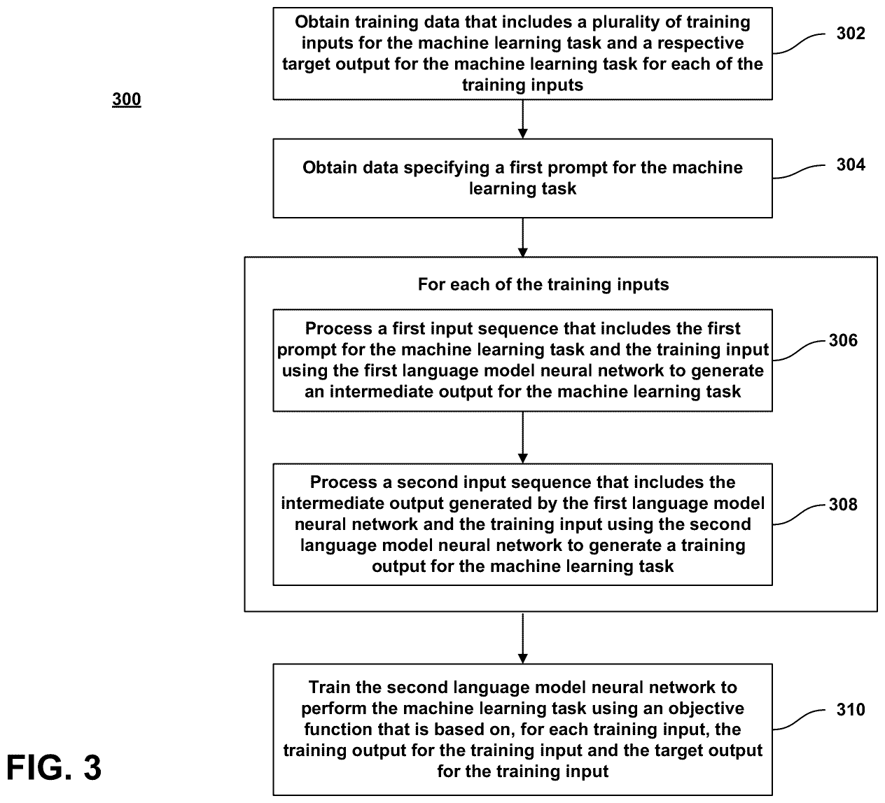

Further details of configuring a first language model neural network and a second language model neural network to perform a machine learning task are described below with reference to FIG. 3.

Generally, the task can be any task that can be performed by a language model neural network.

For example, the machine learning task can be a text processing task.

A “text processing” task is any task that requires processing an input that includes a sequence of text, i.e., a sequence of text tokens, generating an output that includes a sequence of text tokens, or both.

The text tokens can be tokens selected from a vocabulary of text tokens that includes, e.g., one or more of characters, word pieces, words, punctuation marks, numerical symbols, or any other text symbols.

For example, the text processing task can be a text rewriting task that requires processing an input text sequence to generate an output text sequence that is a rewritten version of the input text sequence.

For example, one text rewriting task can be to generate an output text sequence that is a more formal version of the input text sequence but that conveys the same semantic meaning.

As another example, one text rewriting task can be to generate an output text sequence that is a shorter version of the input text sequence but that conveys the same semantic meaning.

As another example, one text rewriting task can be to generate an output text sequence that is a more elaborate version of the input text sequence but that conveys the same semantic meaning.

As another example, one text rewriting task can be to generate an output text sequence that a paraphrased version of the input text sequence, i.e., one that uses different words from the input text sequence but that conveys the same semantic meaning.

As another example, one text rewriting task can be to generate an output text sequence that is a proofread version of the input text sequence, i.e., one that corrects grammar and spelling mistakes in the input text sequence.

As another example, the text processing task can be a task that requires generating an output text sequence that is a completion of an input text sequence.

As another example, the text processing tasks can include a task that requires generating an output text sequence that is an answer to or a response to a query posed by the input text sequence. For example, the inference system can be deployed as part of a “chat bot” or dialog system that responds to queries posed by users.

As another example, the text processing task can be text classification tasks, e.g., tasks that require classifying an input sequence of text into one of multiple categories. Examples of such tasks include entailment tasks, textual similarity tasks, sentiment tasks, grammaticality tasks, and so on.

As another example, the task can be a computer code generation task, where the input is a sequence of text describing the functionality of a piece of computer code, or a sequence of computer code to be modified or completed, or both and the output is a sequence of computed code that modifies the computer code, that has the functionality that is described by the sequence of text, or both.

As yet another example, the task can be an image processing task, e.g., a task that requires processing an input sequence that includes one or more tokens representing an image, e.g., generated by processing the image using a pre-trained encoder neural network. Examples of such tasks include image captioning, e.g., where the input represents an image and the output is a natural language text caption for the image, visual question-answering, where the input includes a text question about an image and tokens representing the image and the output includes a natural language answer to the image, and so on.

The language model neural networks can be any appropriate type of neural networks. For example, each language model neural network can be an auto-regressive self-attention based neural network.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lec, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

Generally, however, the Transformer-based neural network includes a sequence of attention blocks (a block that applies an attention mechanism over a block input to generate a block output), and, during the processing of a given input sequence, each attention block in the sequence receives a respective input hidden state for each input token in the given input sequence. The attention block then updates the hidden state for at least the last token in the input sequence at least in part by applying self-attention. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

FIG. 2 is a flow diagram of an example process 200 to perform inference for a new input of a machine learning task using the set of language model neural networks. For convenience, the process 200 will be described as being performed by a system of one or more computers located in one or more locations. For example, a neural network system, e.g., the neural network system 100 of FIG. 1, appropriately programmed in accordance with this specification, can perform the process 200.

The system receives a new input for a machine learning task (step 202).

The system processes a first input sequence that includes (i) a first prompt for the machine learning task and (ii) the new input using a first language model neural network to generate an intermediate output for the machine learning task (step 204).

The first prompt can be any of a variety of ICL prompts, while the intermediate output is any appropriate output that is responsive to the first input sequence that includes the first prompt and new input.

For example, the first prompt can be a ‘few-shot ICL’ prompt, that is, the first prompt includes a small number of exemplars selected among examples that have been formatted as text input to the model. As a specific example, for the task of solving arithmetic problems, the exemplars can be a series of arithmetic word problems and corresponding responses that include the solution.

As another example, the first prompt can be an ‘instructed ICL’ prompt, that is, the first prompt includes a textual description of the task in the form of instructions. As a specific example, for the task of solving arithmetic problems, a first prompt can be, “Solve the following arithmetic problem that can include the operations of addition, subtraction, multiplication and division. Also, be sure to follow the rules of order of operations when solving the problem.”

As another example, the first prompt can be a ‘chain-of-thought reasoning ICL’ prompt, that is, the first prompt includes a textual description of the task in the form of instructions that induce step-by-step reasoning in the output of the model that improves the model's ability to arrive at a correct prediction. As a specific example, for the task of solving arithmetic problems, a first prompt can be, “Solve the following arithmetic problem by performing the following steps and providing their outputs in the response: (1) identify the operations, e.g., addition, (2) identify the operands, i.e., numbers or results of operations on operands, (3) make groupings of operations and their operands, (4) produce the result of the operations on the operands starting with operations that involve operands that are numbers and obeying order of operations, (5) reverse the operations to check the solution.”

As another example, the first prompt can be a combination of ICL prompt techniques, e.g., ‘few-shot ICL’ and ‘chain-of-thought reasoning’. As a specific example, for the task of solving arithmetic problems, the first prompt can be the following single exemplar that is an example of the task that also includes ‘chain-of-thought’ reasoning:
Q: Billy has 5 golf balls. He buys 2 more packs of golf balls. Each has 3 golf balls. How many golf balls does he have now”
A: Billy started with 5 balls. 2 packs of 3 golf balls each is 6 golf balls. 5+6=11. The answer is 11.

The first prompt can be generated using any of a variety of techniques.

For example, the first prompt can be generated by another system that generates an appropriate first prompt to improve the performance of the machine learning task.

As another example, the first prompt can be generated by a user manually prompt engineering for the machine learning task.

The new input is an example of the machine learning task. For example, for the task of solving arithmetic problems, the new input can be, “Jill bought 3 packs of cookies. Each pack contains 4 cookies. Then she ate 1 cookie during lunch. How many cookies are left?”

The first language model generates the intermediate output as a result of processing the first input sequence. For example, if the task is solving arithmetic problems, the first prompt is the previous ‘few-shot ICL’ and ‘chain-of-thought reasoning’ described earlier, and the new input is the “cookie-Jill problem” described earlier, the first input sequence can be:
Q: Billy has 5 golf balls. He buys 2 more packs of golf balls. Each has 3 golf balls. How many golf balls does he have now”
A: Billy started with 5 balls. 2 packs of 3 golf balls each is 6 golf balls. 5+6=11. The answer is 11.

Q: Jill bought 3 packs of cookies. Each pack contains 4 cookies. Then she ate I cookie during lunch. How many cookies are left?

The first language model can process the first input sequence to generate the intermediate output:
A: Jill started with 0 balls. 3 packs of cookies of 4 cookies each is 12 cookies. 0+12=12. Then Jill ate 1 cookie. 12−1=11. The answer is 11.

For the case that the first prompt is a chain-of-thought prompt for the machine learning task and the intermediate output includes text describing one or more reasoning steps generated by the first language model neural network, the intermediate output is a powerful conditioning factor. That is, the intermediate output improves the performance of the downstream machine learning task performed by the second language model because the intermediate output helps direct how the second language model generates the final output through its inclusion in the second prompt.

The system processes a second input sequence that includes the intermediate output generated by the first language model neural network and the new input using a second language model neural network to generate a final output for the machine learning task (step 206).

In some implementations, the second input sequence includes a second prompt for the machine learning task. Similarly to the first prompt, the second prompt can be any of a variety of ICL prompts, and can be generated by any of a variety of methods.

Similarly to the intermediate output, the second prompt also serves as a conditioning factor to improve the generation of the final output.

FIG. 3 is a flow diagram of an example process 300 for configuring a first language model neural network and a second language model neural network to perform a machine learning task. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The system obtains training data that includes a plurality of training inputs for the machine learning task and a respective target output for the machine learning task for each of the training inputs (step 302).

For example, the system can obtain training data for a machine learning task from another system that includes data from web scraping, data generated by users, data from synthetic generation, and so on.

The system obtains data specifying a first prompt for the machine learning task (step 304). The first prompt can be provided by any appropriate source and be of any appropriate type.

Generally, the first prompt can be a ‘few-shot ICL’, ‘instructed ICL’, ‘chain-of-thought reasoning ICL’, etc., or any combination of these, as described earlier with reference to FIG. 2.

Also generally, the first prompt can be sourced from a user, i.e., a user provides a hand-engineered prompt for the task, or another system that generates the prompt, as described earlier with reference to FIG. 2.

Using ICL for the first prompt avoids catastrophic forgetting by the first language model, i.e., degrading the general first language model performance as a result of training on new data, by only modifying the input to the model while keeping the parameters fixed.

The system processes a first input sequence that includes the first prompt for the machine learning task and the training input using the first language model neural network to generate an intermediate output for the machine learning task (step 306).

For example, the first prompt can be a chain-of-thought prompt for the machine learning task and the intermediate output includes text describing one or more reasoning steps generated by the first language model neural network.

The system processes a second input sequence that includes the intermediate output generated by the first language model neural network and the training input using the second language model neural network to generate a training output for the machine learning task (step 308).

In some cases, the second input sequence includes a second prompt for the machine learning task. Generally, just as is the case for the first prompt as described earlier, the second prompt can be provided by any appropriate source and be of any appropriate type.

When the system is fine-tuning the second language model, the second prompt can help better align a training input with the distribution seen during pre-training, allowing the model to converge faster and make fewer parameter updates.

The system trains the second language model neural network to perform the machine learning task using an objective function that is based on, for each training input, the training output for the training input and the target output for the training input (step 310).

In some implementations, the training output includes a respective probability distribution for each position in the target output, and the objective function measures, for each position, a probability assigned by the probability distribution for the position to a token at the position in the target output. In such implementations, the objective function can be the cross-entropy loss function.

For example, the objective function can be the cross-entropy loss function. The cross-entropy loss function can measure the difference between the training output for the training input and the target output for the training input. That is, the cross-entropy loss measures, for each position in the target output, the negative log probability assigned by the probability distribution for the position to a token at the position in the target output.

Additionally, in some cases, the object function can include regularization terms, i.e., additional components to the loss function that prevents the model from overfitting and improves generalization, e.g., LP-norm terms. Generally, training the second language model neural network includes training the second language model neural network while holding the first language model neural network fixed. That is, generally, the first language model neural network is not trained on the machine learning task.

For example, the system trains the second language model neural network through parameter-efficient fine-tuning. Examples of parameter-efficient fine-tuning include low-rank adaptation of large language models (as described in ArXiv: 2106.09685), prefix tuning (as described in ArXiv: 2110.07602, ArXiv: 2104.08691, or ArXiv: 2103.10385).

As an example of defining parameter-efficient fine-tuning trainable parameters, the system can initialize a first set of parameters of the second language model neural network to pre-trained values and initialize a second set of parameters of the second language model neural network to initialized values and train the second language model neural network on the training output for the training input and the target output for the training input, to update the initialized values while holding the pre-trained values fixed.

As a particular example, the first set of parameters can involve at least a first weight matrix of the second language model neural network, the second set of parameters can involve at least a second low-rank weight matrix and a third low-rank weight matrix, and wherein a product of the second low-rank weight matrix and the third low-rank weight matrix is added to the first weight matrix to generate a final weight matrix that the second language model neural network uses.

As an example of this first and second set of parameters, the system can inject weights of learnable residual modules, i.e., a second set of parameters, to all weights of the pre-trained second language model neural network, i.e., a first set of parameters, to perform low rank adaptations as described in ArXiv: 2106.09685. That is, learnable residual modules ΔW are added to one or more weight matrices W, and ΔWis a composition of low-rank matrices, i.e., W+ΔW=W+AB where WE [symbol] _{n×n}, AE [symbol] _{n×r}, BE [symbol] _{r×n}, r<<n and only the added ΔWis being updated during training while the original parameters W stay frozen.

In addition to being significantly more computationally efficient than fine-tuning all of the parameters of the neural network, the parameter-efficient fine-tuning technique helps the second language model avoid forgetting features that may be useful for generalization beyond the training set and reduces the danger of overfitting.

Generally, given an objective function and a parameter efficient fine-tuning method, the system optimizes the parameters associated with the parameter efficient fine-tuning method using a gradient based method. That is, the system determines values of learnable parameters through repeatedly minimizing a loss function (or more generally an objective function) using parameter updates that include back-propagated estimates of gradients of the loss function (or objective function).

More specifically, the system can repeatedly perform steps 308 and 310 for different sets of one or more training inputs from the larger set of training inputs to train the second language model neural network. For example, at each iteration, the system can randomly sample a set of one or more training inputs from the larger set and then perform the steps 308 and 310 to train the second language model network on the set of one or more training inputs. In some implementations, at each iteration, the system performs step 306 for the one or more training inputs being used to train the second neural network at the training iteration. In some other implementations, the system performs a pre-processing step by performing the step 306 for all of the training inputs before performing any training iterations.

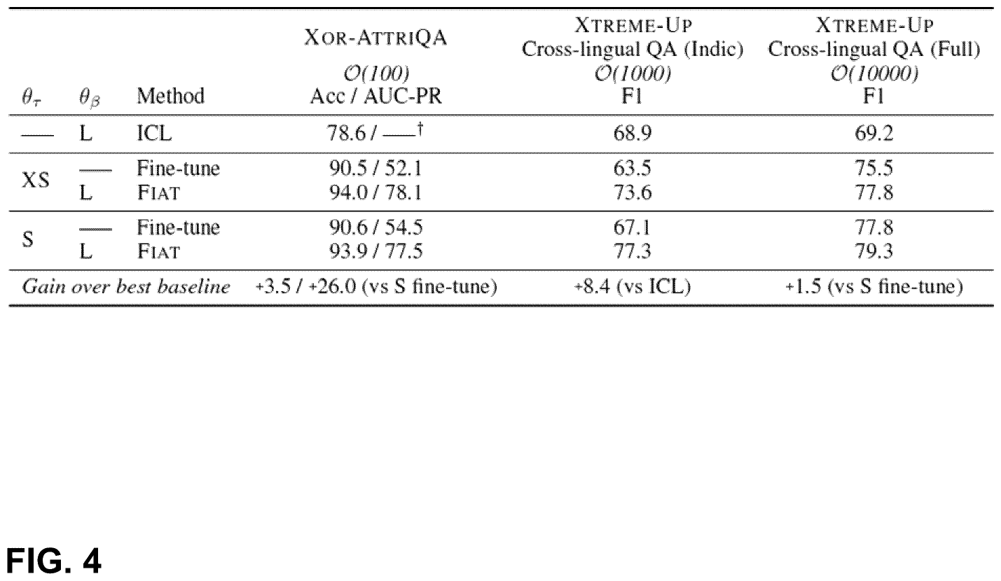

FIG. 4 shows an example 400 of the performance of the described techniques (configuring a set of language model neural networks to perform a machine learning task to perform inference for the task on new input) relative to a conventional baseline technique (i.e., configuring a first language model using ICL, or configuring a second language model using fine-tuning) on a cross lingual question answering task, i.e., predict the correct English answer given a non-English question and an English answer passage.

The entries to the columns labeled as ‘θ_{τ}’, ‘θ_{β}’, and ‘Method’ determine if the task performance, e.g., accuracy, area under precision recall curve (AUC-PR), and F1-score, with respect to datasets, e.g., Xor-ATTRIQA, and XTREME-UP Cross-lingual QA (Indic or Full), refer to the described techniques or baselines. The described techniques are indicated by any entry where the column ‘Method’ is ‘FIAT’. When ‘Method’ is ‘ICL’ the entry refers to the baseline of configuring a first language model using ICL, and when ‘Method’ is ‘Fine-Tune’ the entry refers to the baseline of configuring a second language model using full fine-tuning. The column denoted by θ_{τ}, indicate if the first language model is Palm-2 L with the entry of L, and the column denoted by θ_{β} indicates if the second language model is Palm-2 S with the entry S or Palm-2 XS with the entry XS. An entry of a dash-refers to the absence of the first language model or the second language model for a baseline.

As can be seen from example 400, the described techniques, i.e., entries where ‘Method’ is ‘FIAT’ outperform relevant baselines for all datasets across all metrics. This indicates the robustness and effectiveness of the described techniques in enhances task performance accuracy and generalization.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a new input for a machine learning task;
processing a first input sequence comprising (i) a first prompt for the machine learning task and (ii) the new input using a first language model neural network to generate an intermediate output for the machine learning task; and
processing a second input sequence comprising the intermediate output generated by the first language model neural network and the new input using a second language model neural network to generate a final output for the machine learning task.

2. The method of claim 1, wherein the first machine learning model has been pre-trained on a second, different machine learning task that is different from the machine learning task.

3. The method of claim 2, wherein the second machine learning model has been pre-trained on a third, different machine learning task that is different from the machine learning task and then fine-tuned on the machine learning task.

4. The method of claim 3, wherein the second machine learning model has been fine-tuned on the machine learning task through parameter-efficient fine-tuning.

5. The method of claim 2, wherein the second machine learning task, the third machine learning task, or both is a language modeling task.

6. The method of claim 1, wherein the second input sequence further comprises a second prompt for the machine learning task.

7. The method of claim 1, wherein the first prompt is a chain-of-thought prompt for the machine learning task and the intermediate output comprises text describing one or more reasoning steps generated by the first language model neural network.

8. A method performed by one or more computers and for configuring a first language model neural network and a second language model neural network to perform a machine learning task, the method comprising:
obtaining training data comprising a plurality of training inputs for the machine learning task and a respective target output for the machine learning task for each of the training inputs;
obtaining data specifying a first prompt for the machine learning task;
for each of the training inputs:
processing a first input sequence comprising the first prompt for the machine learning task and the training input using the first language model neural network to generate an intermediate output for the machine learning task; and
processing a second input sequence comprising the intermediate output generated by the first language model neural network and the training input using the second language model neural network to generate a training output for the machine learning task; and
training the second language model neural network to perform the machine learning task using an objective function that is based on, for each training input, the training output for the training input and the target output for the training input.

9. The method of claim 8, wherein the first prompt is a chain-of-thought prompt for the machine learning task and the intermediate output comprises text describing one or more reasoning steps generated by the first language model neural network.

10. The method of claim 8, further comprising:
obtaining a second prompt for the machine learning task, wherein the second input sequence comprises the second prompt.

11. The method of claim 8, wherein training the second language model neural network to perform the machine learning task comprises:
training the second language model neural network through parameter-efficient fine-tuning.

12. The method of claim 8, wherein the second input sequence further comprises the target output for the training input, wherein the training output comprises a respective probability distribution for each position in the target output, and wherein the objective function measures, for each position, a probability assigned by the probability distribution for the position to a token at the position in the target output.

13. The method of claim 8, wherein the first language model neural network has more parameters than the second language model neural network.

14. The method of claim 8, wherein the first language model neural network is not trained on the machine learning task.

15. The method of claim 8, wherein training the second language model neural network comprises:
training the second language model neural network while holding the first language model neural network fixed.

16. A system comprising:
one or more computers; and
one or more storage devices storing instructions that, when executed by the one or more computers, cause the one or more computers to perform operations comprising:
receiving a new input for a machine learning task;
processing a first input sequence comprising (i) a first prompt for the machine learning task and (ii) the new input using a first language model neural network to generate an intermediate output for the machine learning task; and
processing a second input sequence comprising the intermediate output generated by the first language model neural network and the new input using a second language model neural network to generate a final output for the machine learning task.

17. The system of claim 16, wherein the second machine learning model has been fine-tuned on the machine learning task through parameter-efficient fine-tuning.

18. The system of claim 16, wherein the second machine learning task, the third machine learning task, or both is a language modeling task.

19. The system of claim 16, wherein the second input sequence further comprises a second prompt for the machine learning task.

20. The system of claim 16, wherein the first prompt is a chain-of-thought prompt for the machine learning task and the intermediate output comprises text describing one or more reasoning steps generated by the first language model neural network.
